(19) United States
(12) Patent Application Publication
(10) Pub. No.: US 2007/0091850 A1
(43) Pub. Date: Apr. 26, 2007

(54) Method of performing handover in mobile IP environment

(76) Inventors: Joo Chul Lee, Daejeon-city (KR); Hyoung Jun Kim, Daejeon-city (KR)

Correspondence Address: LADAS & PARRY LLP, 224 SOUTH MICHIGAN AVENUE, SUITE 1600, CHICAGO, IL, 60604, US

(21) Appl. No.: 11/585,744

(22) Filed: Oct. 24, 2006

(30) Foreign Application Priority Data
Oct. 25, 2005 (KR) 10-2005-0100871

(51) Int. Cl. H04Q 7/00

(52) U.S. Cl. 370/331

(57) ABSTRACT

Provided is a method of performing a handover in a mobile communication environment. The method of performing the handover using a mobile node (MN) that moves from a first access router (AR) network to a second AR network in a mobile Internet protocol (IP) network includes: (a) the MN providing a new care of address (CoA) allocation method to the second AR, the second AR previously obtaining a CoA according to the CoA allocation method; (b) after the MN completely performing the handover to a subnet of the second AR in a layer 2 of the MN, clearly informing the first AR that the MN moves; and (c) allocating a new CoA (NCoA) obtained by the second AR to the MN, the first AR starting to tunnel packets destined for a previous CoA (PCoA) to the NCoA, and normally performing a binding update process for a mobile IP. The method replaces a conventional fast handover method, and simplifies complicated message exchanges.

### BACKGROUND OF THE INVENTION

This application claims the benefit of Korean Patent Application No. 10-2005-0100871, filed on Oct. 25, 2005, in the Korean Intellectual Property Office, the disclosure of which is incorporated herein in its entirety by reference.

1. Field of the Invention

The present invention relates to a method of performing a handover in a mobile communication environment, and more particularly, to a method of simplifying a message structure in a fast handover, and anticipating a movement of a mobile node when the mobile node moves from a mobile Internet protocol (IP) network to a new network to solve a ping-pong problem, and a computer readable recording medium storing the method.

2. Description of the Related Art

The information/telecommunication (IT) industry is greatly interested in Internet protocol (IP) networking such as mobile communication and the Internet. Mobile communication has increased owing to wireless mobile communication nodes, and integrates wireless local area networks (LAN) and IP-based networks. IP networking urgently requires IP addresses due to the integration of the IP-based network. To this end, a next-generation Internet protocol version 6 (IPv6) protocol has been introduced (hereinafter referred to as IPv6).

In an IP network, IP addresses serve as identifiers of each of a plurality of nodes, and change since a host moves an IP domain (a subnet). That is, when the host moves in the IP network, the IP address allocated to the host changes, which is contrary to IP communication characteristics that the IP address allocated to both ends of an IP connection does not change until connection is broken. Therefore, when a node moves to another IP subnet, communication is impossible.

To solve this problem, a mobile IP has been suggested. If a mobile node (MN) moves to an IP domain, a current IP address remains unchanged, and a care of address (CoA) suitable for the moved IP domain is allocated.

To this end, the movement of the MN must be sensed and time required to allocate a new CoA to be used in a new network must be minimized in the mobile IP. Such a process is called a handover (the movement from MN 140 to MN 160 in FIG. 1), and the time required to perform the handover is called a handover delay time. If the handover delay time is increased, it is inconvenient for users packets of an important application may be lost during the handover delay time. To minimize the handover delay time, the Internet Engineering Task Force (IETF) provides fast handover standards for mobile IPv6 (hereinafter referred to as “the fast handover”). The fast handover specifies the following three important factors:

A) time for generating the CoA in a new subnet

B) time for sensing the MN in an access router of the new network

C) measure for minimizing loss of packets between the MN and a correspondent node (CN communicating with the MN) during the movement of the MN to the new subnet

To minimize the handover delay time regarding the three factors, the MN has information on an access router next to an access router to which the MN is currently connected, and quickly senses the movement to a new subnet using information provided from a layer 2. The information is provided to the access router to which the MN is currently connected to pre-allocate the new CoA to be used in the new subnet, thereby reducing time required to allocate the CoA. The fast handover provides a shorter handover delay time than a handover provided in a basic specification of the mobile IP. However, since the fast handover pre-allocates the CoA using a complicated structure and handover expectation information provided in the layer 2, if an access point (AP) and a boundary of the AP do not perform an expected handover, the MN and an access router to which the MN belongs perform an unnecessary operation, which is called ping-pong.

FIG. 2 is a view for illustrating a conventional fast handover method. Referring to FIG. 2, when the MN 160 senses network movement trigger information from the link layer, the MN 160 sends a router solicitation for proxy advertisement (RtSolPr) message to a previous access router (PAR) 110 to which the MN 160 is currently connected (Operation 201). The PAR 110 which receives the RtSolPr message sends a proxy router advertisement (PrRtAdv) message including a layer 2 address, an IP address, etc. of a next access router (NAR) 120 next to the PAR 110 to the MN 160 (Operation 202). The MN 160 generates a new CoA (NCoA) to be used in a link of the NAR 120 using the information included in PrRtAdv message, and sends a fast binding update (FBU) message to the PAR 110 (Operation 203).

The PAR 110 generates a tunnel between a previous CoA and the NCoA after receiving the FBU message, such that, after the MN 160 moves to a new link, packets transmitted to the previous CoA can be delivered to the MN 160 in the link of the NAR 120 until a binding update operation is completed.

The PAR 110 performs a handover initiate (HI)/handover acknowledge (HAck) operation (Operations 204 and 205) in order to check the effectiveness of the NCoA included in the FBU message and deliver quality of service (QoS) or access control that is applied to the MN 160 in a previous network to a new network. After completing the HI/HAck operation, the PAR 110 delivers an FBAck message to the MN 160 and the NAR 120 to start communication using the NCoA (Operation 206).

When the MN 160 completely moves to the new link, the MN 160 sends a fast neighbor advertisement (FNA) message indicating that the MN 160 completely moves to the new link to the NAR 120. The NAR 120 starts forwarding buffered packets that are tunneled to the NCoA to the MN 160 immediately after receiving the FNA message. The subsequent process is the same as the binding update process performed in the mobile IP. The conventional method of performing the handover has the problems as mentioned above.

### SUMMARY OF THE INVENTION

The present invention provides a handover method of simplifying a message structure in a fast handover, expecting a movement of a mobile node (MN), and controlling a time for allocating a new care of address (NCoA) which is previously generated and allocated to solve a ping-pong problem, and a computer readable recording medium storing the method.

### BRIEF DESCRIPTION OF THE DRAWINGS

The above and other features and advantages of the present invention will become more apparent by describing in detail exemplary embodiments thereof with reference to the attached drawings in which:

FIG. 1 is a diagram illustrating a handover;

FIG. 2 is a view for illustrating a conventional fast handover method;

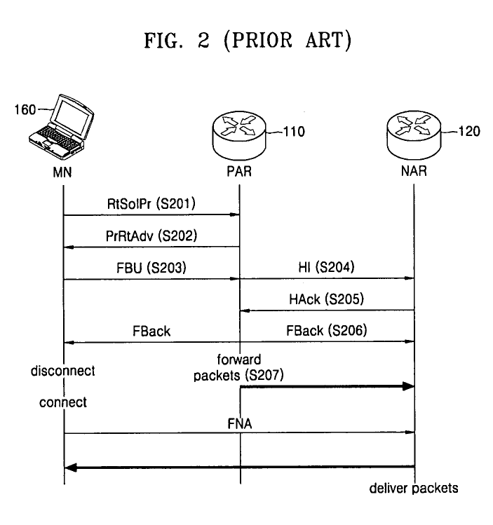

FIG. 3 is a flowchart illustrating message exchanges and operations for performing a handover in a mobile IP environment according to an embodiment of the present invention; and

FIG. 4 is a diagram of realizable handover scenarios according to an embodiment of the present invention.

### DETAILED DESCRIPTION OF THE INVENTION

The present invention will now be described more fully with reference to the accompanying drawings, in which exemplary embodiments of the invention are shown. The invention may, however, be embodied in many different forms and should not be construed as being limited to the embodiments set forth herein; rather, these embodiments are provided so that this disclosure will be thorough and complete, and will fully convey the concept of the invention to those skilled in the art. Like reference numerals in the drawings denote like elements, and thus their description will be omitted.

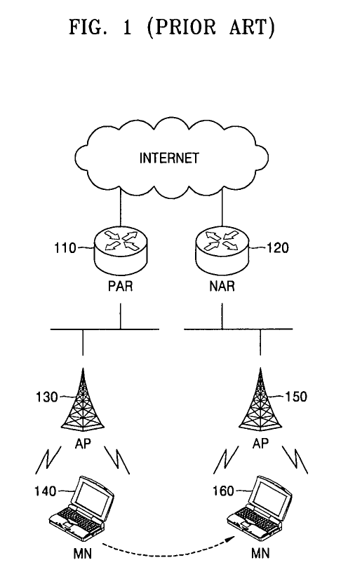

A handover environment to which a method of performing a handover in a mobile Internet protocol (IP) environment according to an embodiment of the present invention is applied will now be described with reference to FIG. 1. FIG. 1 is a diagram illustrating the handover according to an embodiment of the present invention. Referring to FIG. 1, the mobile IP environment comprises a previous access router (PAR) 110 to which a mobile node (MN) 140 is currently connected and a next access router (NAR) 120 to which a MN 160 is connected.

The MN that is a mobile node supporting a mobile Internet protocol version 6 (IPv6) protocol performs the handover. The MN changes an AR that forwards traffic of a network to which the MN is connected as the MN moves between networks (from the MN 140 to the MN 160). Also, when the MN moves between networks, its home address (HoA) allocated in a first network does not change but its care of address (CoA) necessary for a communication changes. The changed CoA is informed of a correspondent node (CN) communicating with the MN, which is called a binding update process. Also, the AR and the MN connect to each other via a wireless local area network (LAN WLAN).

The PAR 110 and the NAR 120 that are connected to the Internet sequentially change as the MN 140 moves to the MN 160. The PAR 110 and the NAR 120 basically support the mobile IPv6 protocol, and realize the method of performing the handover according to the current embodiment of the present invention.

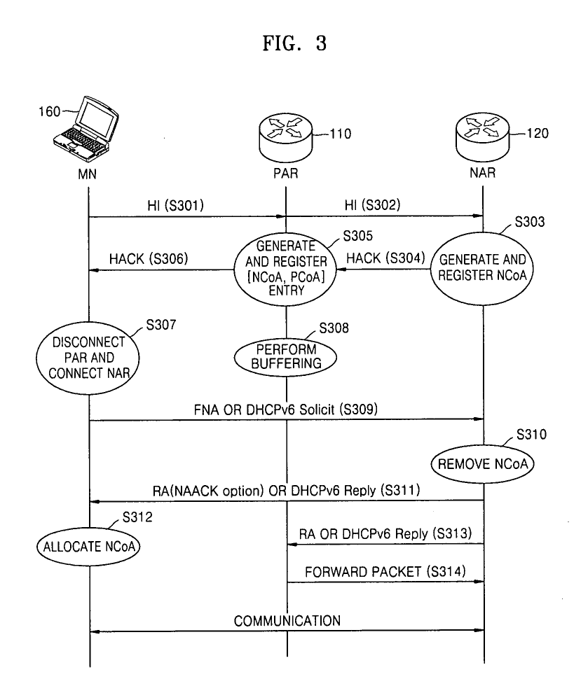

A communication method that uses the method of performing the handover according to an embodiment of the present invention will now be described with reference to FIG. 3.

FIG. 3 is a flowchart illustrating message exchanges and operations for performing the handover in a mobile IP environment according to an embodiment of the present invention. Referring to FIG. 3, when the MN 160 senses a new access point (AP) (i.e., when the MN 160 is expected to be moved in a link layer), the MN 160 sends a handover initiate (HI) message including ID information on the AP to the PAR 110 (Operation 301).

The PAR 110 sends the HI message including the APID information, an address of the layer 2 a layer 2 address of the MN 160, and an address allocation method that the MN 160 desires to the NAR 120 (Operation 302). The address allocation method selected by the MN 160 may be a stateless or a stateful method. The stateless method follows the IPv6 stateless address autoconfiguration (RFC-2462), and the stateful method uses a dynamic host configuration protocol for the IPv6 (DHCPv6) (RFC-3315) protocol.

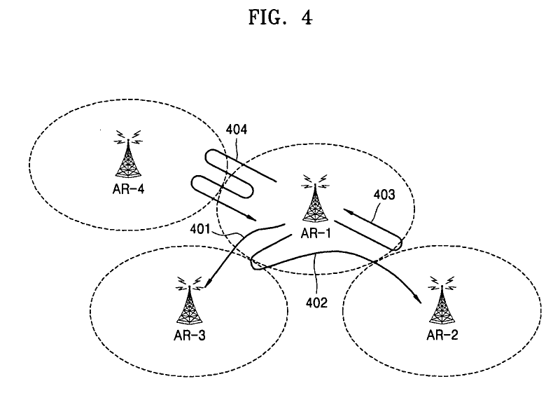

The NAR 120 which receives the HI message generates a new CoA (NCoA) for the MN 160 using the address allocation method and additional information (the link layer address of the MN 160) included in the HI message, and registers the NCoA in a timer list (Operation 303). The reason for registering the NCoA in the timer list will be described later with reference to FIG. 4. A method of generating the NCoA according to the address allocation method included in the HI message is described below.
The stateless method: the NCoA is generated using the stateless address autoconfiguration method specified in the IPv6 stateless address autoconfiguration (RFC-2462).
The stateful method: if a DHCPv6 server satisfying the DHCPv6 (RFC-3315) is implemented in the NAR 120, the NAR 120 allocates an available address in its address pool. The NAR 120 is responsible for checking duplicate address detection (DAD) in a subnet of the NAR 120. Although the MN 160 prefers to use the stateful method, if the NAR 160 does not support the stateful method, the NAR 120 generates the NCoA using the stateless method, and returns a handover acknowledge (HAck) message indicating the address allocation method as the stateless method.

The NAR 120 sends the HAck message including the generated NCoA to the PAR 110 (Operation 304). The PAR 110 generates an [NCoA, previous CoA (PcoA)] entry and registers the entry in the timer list (Operation 305). The entry is required to tunnel packets destined for the PCoA to the NCoA. Also, the PAR 110 sends the HAck message including the address allocation method adopted by the NAR 120 and an address of the NAR 120 to the MN 160 (Operation 306).

The MN 160 completely performs layer 2 handover from a network of the PAR 110 to a network of the NAR 120 (Operation 307), which may cause some packet loss. To reduce the packet loss, if the PAR 110 fails to check neighbor unreachable detection (NUD) for the MN 160, the PAR 110 buffers the packets destined for the PCoA (Operation 308).

After sensing the complete movement to the network of the NAR 120, the MN 160 sends a fast neighbor advertisement (FNA) message or a DHCPv6 solicit message (including a rapid commit option) according to the address allocation method to the NAR 120 to clearly inform that the MN 160 has moved to the network of the NAR 120 (Operation 309).

The NAR 120 which receives the FNA message or the DHCPv6 solicit message removes the previously allocated NCoA from the timer list using the link layer address of the MN 160 (Operation 310).

The NAR 120 sends an RA message or a DHCPv6 replay message including the NCoA to the MN 160 (Operation 311). The MN 160 uses the NCoA included in the RA message or the DHCPv6 replay message to the MN 160 (Operation 312).

The NAR 120 also sends the RA message or the DHCPv6 replay message to the PAR 110 (Operation 313) so that the PAR 110 forwards a buffered packets destined for the PCoA to the NCoA (Operation 314).

Thereafter, the MN 160 starts the binding update process, and the PAR tunnels the packets destined for the PCoA to the NCoA until the binding update process ends.

The current embodiment of the present invention relates to a scenario 401 illustrated in FIG. 4 and is the most common scenario. Some other handover scenarios will now be described with reference to FIG. 4.

FIG. 4 is a diagram of realizable handover scenarios according to an embodiment of the present invention. Referring to FIG. 4, a second scenario 402 is that an MN actually moves from an AR-1 network to an AR-2 network while pretending to move from the AR-1 network to an AR-3 network. In this regard, an NCoA for the MN is generated in the AR-3 and is not actually used. The NAR 120 generates the NCoA and adds the NCoA to a timer list. Although the NCoA is generated, if a subsequent handover is not performed, the previously generated NCoA times out and is removed from the timer list. If the MN intends to move to the NAR 120 to which MN have tried to move, an address of a layer 2 of the MN is searched to determine whether the NCoA is previously generated. If it is determined that the NCoA is previously generated, a timer of the previously generated NCoA entry is updated. If it is determined that the NCoA is not previously generated, a new entry is generated.

A third scenario 403 is that the MN returns to the PAR 110 network before the handover is finished. In this regard, like the second scenario 402, the NCoA is generated in the AR-2 and no further process is performed. Therefore, a timer of the NCoA expires and the NCoA is removed.

A fourth scenario 404 is that the MN moves quickly to both neighboring ARs (what is called a ping-pong scenario). According to the current embodiment of the present invention, the MN delays allocation time of the NcoA as possible as it can at the least, so that the PAR 110 does not start tunneling to the NCoA even if the MN moves back to its first network without completely performing the handover, thereby continuously communicating with the PAR 110. Also, if the MN moves quickly to neighboring ARs, and the NCoA is previously registered in the timer list, a lifetime is only updated, and there is no problem in performing the handover. If the MN moves between both neighboring ARs in a sufficient time interval to completely perform the handover, the subsequent handover is performed according to mobile IPv6 standards.

The present invention can also be embodied as computer readable code on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves. The computer readable recording medium can also be distributed network coupled computer systems so that the computer readable code is stored and executed in a distributed fashion.

A method of performing a fast handover in a mobile IP environment according to the present invention replaces a conventional method, simplifies complicated message exchanges, anticipates the movement of a MN, and controls NCoA allocation time that is previously generated and allocated, and tunnels packets destined for a PCoA to the NCoA, thereby solving a ping-pong problem.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of performing a handover using a mobile node (MN) that moves from a first access router (AR) network to a second AR network in a mobile Internet protocol (IP) network, the method comprising:
(a) the MN providing a new care of address (CoA) allocation method to the second AR, the second AR previously obtaining a CoA according to the CoA allocation method;
(b) after the MN completely performing the layer 2 handover to a subnet of the second AR, clearly informing the first AR that the MN moves; and
(c) allocating a new CoA (NCoA) obtained by the second AR to the MN, the first AR starting to tunnel packets destined for a previous CoA (PCoA) to the NCoA, and normally performing a binding update process for a mobile IP.

2. The method of claim 1, wherein operation (a) comprises:
(a1) the MN sensing movement in the link layer of the MN and transmitting predetermined first handover information to the first AR;
(a2) obtaining an address of the second AR based on the first handover information and transmitting predetermined second handover information to the second AR;
(a3) the second AR generating the NCoA for the MN, registering the NCoA in a timer list, and transmitting predetermined third handover information to the first AR; and
(a4) the first AR transmitting predetermined fourth handover information comprising an NCoA allocation method required by the MN to the MN.

3. The method of claim 2, wherein the first handover information includes ID information of the second AR, a link layer address of the MN, and an address allocation method required by the MN,
the second handover information comprises a link layer address of the MN and the PCoA,
the third handover information comprises the NCoA and the CoA allocation method.

4. The method of claim 1, wherein operation (b) comprises:
(b1) the MN completely performing the layer 2 handover to a subnet of the second AR;
(b2) the MN informing the second AR that the MN moves to the subnet of the second AR through a message based on the NCoA allocation method; and
(b3) allocating the NCoA obtained in operation (a).

5. The method of claim 1, wherein operation (c) comprises:
(c1) allocating the CoA obtained in operation (a) to the MN using a message based on the NCoA allocation method;
(c2) transmitting the message to the first AR and requesting to tunnel the packets transmitted to the PCoA to the NCoA; and
(c3) starting mobile IP binding update procedure.

6. The method of claim 4, wherein the message is one of a fast neighbor advertisement (FNA) message and a dynamic host configuration protocol for IPv6 (DHCPv6) solicit message.

7. The method of claim 5, wherein the message is one of a fast neighbor advertisement (FNA) message and a dynamic host configuration protocol for IPv6 (DHCPv6) solicit message.

8. The method of claim 2, wherein operation (a3) further comprises: after the generation of the NCoA by the second AR, if the second AR determines that the MN does not move to the second AR network, removing the NCoA from the timer list.
